(19) United States
(12) Patent Application Publication
(10) Pub. No.: US 2020/0410509 A1
(43) Pub. Date: Dec. 31, 2020

(54) Supply Chain Data Collection Method and System Compatible with Standard Article Coding, and Server

(71) Applicant: Song Xu, Zhongshan, Guangdong (CN)

(72) Inventor: Song Xu, Zhongshan, Guangdong (CN)

(21) Appl. No.: 16/968,513

(22) PCT Filed: Feb. 3, 2019
(86) PCT No.: PCT/CN2019/074687

§ 371 Date: Aug. 7, 2020

(30) Foreign Application Priority Data
Feb. 7, 2018 (CN) 201810123397.1

(51) Int. Cl. G06Q 30/00; G06Q 50/28; G06Q 30/06; G06K 7/14; G06F 16/27

(52) U.S. Cl. CPC G06Q 30/0185; G06Q 50/28; G06F 16/27; G06K 7/1413; G06K 7/1417; G06Q 30/0633

(57) ABSTRACT

A supply chain data collection method compatible with standard article coding is disclosed. A general barcode of a commodity and an identification code presented in a plain code manner are arranged in the same identification area on a commodity package, and the identification code is arranged at a non-general barcode dead zone (S1). The identification area is scanned by a code scanning identification system arranged in a supply chain circulation link, and the general barcode and the identification code of the commodity are read and identified to collect the identification information of the commodity (S2). User information and the identification information are associatively stored in a database to realize collection of commodity supply chain data corresponding to the identification information (S3). A foundation is laid for the realization of “one article, one code” anti-counterfeiting traceability.

### TECHNICAL FIELD

The present invention belongs to the technical field of supply chain commodity circulation, and more particularly relates to a supply chain data collection method and system compatible with standard article coding, and a server.

### BACKGROUND

Article coding is digital “thing” information, and it is the cornerstone of modernization and informatization. New concepts, new technologies, and new applications such as supply chain innovation, Internet of Things, big data, cloud computing, and smart earth that have emerged in recent years are still based on article coding. A data carrier of an article coding system is mainly barcodes, and radio frequency tags are also being explored as new technologies. The most widely used standard article coding system is GS1 system coding (of course, there are other coding systems such as Code bar). Most of the commodity or goods general barcodes currently circulating in the domestic and international markets use EAN/UPC barcodes and UCC/EAN-128 barcodes in the GS1 system.

Supply chain standardization, informatization, and intelligent innovation are key areas of supply-side reforms. However, general barcode machine reading based on a traditional supply chain informatization technology has two defects: firstly, a general barcode itself can only reflect the type attribute of a commodity and cannot reflect the individual attributes of a single commodity, so there are defects in the standardization and rapid collection of data; and secondly, the circulation of fake and inferior products cannot be prevented.

Most of the existing “one article, one code” anti-counterfeiting traceability technical measures use the “anti-counterfeiting code” as the anti-counterfeiting feature. The disadvantage of this technology is that once the anti-counterfeiting feature is copied in a commodity circulation process, it will not play the role of anti-counterfeiting traceability. Of course, covering coatings or hiding anti-counterfeiting features in the package can avoid this defect, but also brings inconvenience to the query. More importantly, these anti-counterfeiting and traceability technical measures are isolated and cannot be linked to the standardized and rapid collection of supply chain data with individual attributes of commodities.

In order to solve the above technical shortcomings, a technology called “electronic supervision code” has appeared on the market, that is, a barcode of one article and one code is arranged on a commodity outer package, the barcode is collected by a code scanning identification device in each circulation link of a supply chain to form supply chain data, and the supply chain data is used to realize anti-counterfeiting traceability. However, this technology also has drawbacks: because the barcode is separated from the general barcode of the commodity, in a cashier link of a shopping mall, a cashier must first determine whether the commodity has an “electronic supervision code”, manually distinguish the “electronic supervision code” from the general barcode, scan the general barcode to enter a POS machine cash register, and scan the “electronic supervision code” to collect supply chain data, so that the working efficiency is reduced, but more importantly, there is the possibility of human factors scanning a wrong barcode or missing the “electronic supervision code”. In the field of anti-counterfeiting and traceability, the human factor affecting supply chain data collection is not allowed and will greatly reduce the credibility of data. Therefore, in practical applications, this technology can only be applied to certain relatively closed specialized markets, and supply chain data can only cover logistics and warehousing, and cannot be fully promoted.

### SUMMARY

In order to solve the above problems in the conventional art, the present invention provides a supply chain data collection method and system, and a server, which are fully compatible with an existing standard article coding system, can quickly complete the automated collection of supply chain data with only one scanning operation, lay a foundation for “one article, one code” anti-counterfeiting traceability, effectively simplify the operation steps of each circulation link in the supply chain and shorten the operation time, and have high supply chain data collection and identification efficiency.

In order to solve the above technical problem, the present invention adopts the following technical solutions.

A supply chain data collection method compatible with standard article coding includes the following steps.

A general barcode of a commodity and an identification code presented unobstructed are arranged in the same identification area on a commodity package, and the identification code is arranged at a non-general barcode quiet zone. Identification information of the commodity is contained in a combination of the general barcode and the identification code or in the identification code.

The identification area is scanned by a code scanning identification system arranged in a supply chain circulation link, and the general barcode and the identification code of the commodity are read and identified to collect the identification information of the commodity.

User information and the identification information are associatively stored in a database to realize collection of commodity supply chain data corresponding to the identification information.

Further, the identification information of the commodity is pre-stored in the database as an identity registration of the commodity, and after the identification information of the commodity is collected by the code scanning identification system, the identification information and the user information of the code scanning identification system are sent to a database server.

Before associatively storing the user information and the identification information, the database server verifies whether the identification information sent by the code scanning identification system has been pre-stored in the database, and if yes, the database server associates the user information with the identification information for storage to realize the verification of supply chain data.

Further, after scanning the identification area to read and identify the general barcode and the identification code of the commodity, the code scanning identification system arranged in the supply chain circulation link sends general barcode information to an information management system of the circulation link to complete data update of the information management system of the circulation link.

Further, after completing the collection of the commodity supply chain data, the database server generates a circulation sequence of the commodity according to the commodity supply chain data, and verifies whether the circulation sequence of the commodity matches a preset legal circulation sequence in the database server.

If yes, it is determined that the commodity passes the traceability and/or anti-counterfeiting verification.

Further, the user information of the code scanning identification system includes at least one of number, owner, and geographic location of the code scanning identification system.

Further, the identification code is a character or a one-dimensional/two-dimensional barcode.

Further, the identification code is printed after superimposing color and/or grayscale information on a general barcode area of the commodity.

Further, the general barcode is one of an EAN/UPC barcode and a UCC/EAN-128 barcode, or one of a one-dimensional EAN/UPC barcode and a UCC/EAN-128 barcode in a composite code.

Further, when a commodity package is a collective product outer package, identification information contained in a general barcode and an identification code arranged on the commodity package and identification information contained in general barcodes and identification codes of a plurality of commodities in the commodity package form a unique correspondence, and the correspondence is stored in the database to obtain identification information of each commodity in an outer package by querying identification information of a commodity on the outer package.

Further, a collective commodity outer package is provided with a commodity code with a barcode and/or radio frequency tag as a unique commodity identification mark, the commodity code information is stored in the database, the commodity code information and identification information contained in general barcodes and identification codes of a plurality of commodities in the collective commodity outer package form a unique correspondence, and the correspondence is stored in the database to obtain identification information of each commodity in the outer package by querying the commodity code on the collective commodity outer package.

Further, the method is implemented based on a blockchain technology, the database is a distributed database adopting the blockchain technology, and the identification information and associated supply chain data information are stored in the distributed database of a blockchain.

A supply chain data collection system compatible with standard article coding includes:

a general barcode and an identification code, arranged in the same identification area on a commodity package unobstructed, the identification code being arranged at a non-general barcode quiet zone, wherein identification information of a commodity is contained in a combination of the general barcode and the identification code or in the identification;

a scanning identification system, arranged in a supply chain circulation link, including a code scanning identification sub-system and a communication device, and configured to scan the identification area of the commodity to read and identify the general barcode and the identification code of the commodity to collect the identification information of the commodity, and send the collected information and user information of the code scanning identification system by the communication device via a network to a database server; and

the database server, communicatively connected to the code scanning identification system of each supply chain circulation link, and configured to store identification information contained in the general barcode and the identification code, the user information of the code scanning identification system in each supply chain circulation link associated with the identification information, and verify and feed back the received identification information of the commodity and the user information of the code scanning identification system.

Further, the scan code identification sub-system includes an optical lens sub-system, a photoelectric sensing sub-system, an analog-to-digital conversion circuit sub-system, and a decoding sub-system, the photoelectric sensing sub-system is a photoelectric conversion module that converts optical signals into electrical signals, and the decoding sub-system is an identification system capable of simultaneously decoding general barcodes and identification codes of commodities.

Further, the code scanning identification system is a computer system including a code scanning gun or a smart shelf or a smart shopping cart or a smart logistics tray, or a smart phone or tablet with a camera.

Further, the code scanning identification system and the database server are also connected to an online payment platform, and when the code scanning identification system identifies commodity identification information that is checked by the database server, a payment instruction is sent to the online payment platform directly or through the database server.

Further, the code scanning identification system and the database server are also connected to an online shopping platform, and when the code scanning identification system identifies commodity identification information that is checked by the database server, commodity information is transmitted or a payment purchasing instruction is sent to the online shopping platform directly or through the database server.

Further, the system is established based on a blockchain technology, the database server is composed of distributed storage nodes of a blockchain, and the identification information of a commodity and associated supply chain data are stored in the blockchain.

A supply chain database server compatible with standard article coding includes:

a receiving unit, configured to receive identification information of a commodity sent by a code scanning identification system in a supply chain circulation link, and own user information of the code scanning identification system, wherein the identification information of the commodity is contained in a combination of a general barcode and an identification code or in an identification code, the general barcode and the identification code are arranged in the same identification area on a commodity package unobstructed, and the identification code is arranged at a non-general barcode quiet zone; and

a storage unit, configured to store the identification information of the commodity received by the receiving unit, and the user information of the code scanning identification system.

Further, the storage unit pre-stores identification information as a commodity identity registration.

The database server further includes a verification unit for verifying whether the identification information of the commodity received by the receiving unit and sent by the code scanning identification system has been pre-stored in the storage unit before the storage unit stores the identification information of the commodity and the user information of the code scanning identification system, if yes, the verification unit confirms that the identification information of the commodity is verified, and then the storage unit associates the user information of the code scanning identification system with the identification information for storage.

Further, the receiving unit is further configured to receive a data request message of a user terminal.

The database server further includes a query unit configured to query information stored in the storage unit that meets the requirements of the data request message according to the received data request message.

The database server further includes a sending unit configured to send the information that meets the requirements of the data request message to the user terminal.

The beneficial effects of the present invention are as follows.

By means of the above technical solutions, the present invention can be fully compatible with an existing standard article coding system, can quickly complete the collection of supply chain data with only one scanning operation, lays a foundation for “one article, one code” anti-counterfeiting traceability, effectively simplifies the operation steps of each circulation link in the supply chain and shortens the operation time, and improves supply chain data collection and identification efficiency. Moreover, the wrong scanning of wrong barcodes or missing scanning of identification codes caused by human factors is avoided, the integrity and credibility of supply chain data are improved, and it is also fully compatible with the existing standard article coding system, is easy to be accepted by all merchants in the supply chain, and is conducive to all-round promotion and application.

### BRIEF DESCRIPTION OF THE DRAWINGS

FIG. 1 is a schematic flowchart of embodiments of a supply chain data collection method and system compatible with standard article coding according to the present invention; and

FIG. 2 is a schematic structure diagram of an embodiment of a supply chain data collection system compatible with standard article coding according to the present invention.

### DETAILED DESCRIPTION OF THE EMBODIMENTS

In order to make the purposes, technical solutions and advantages of the present invention clearer, the present invention will be further described in detail below with reference to the accompanying drawings and embodiments. It is to be understood that the specific embodiments described herein are merely illustrative of the present invention and are not intended to limit the present invention.

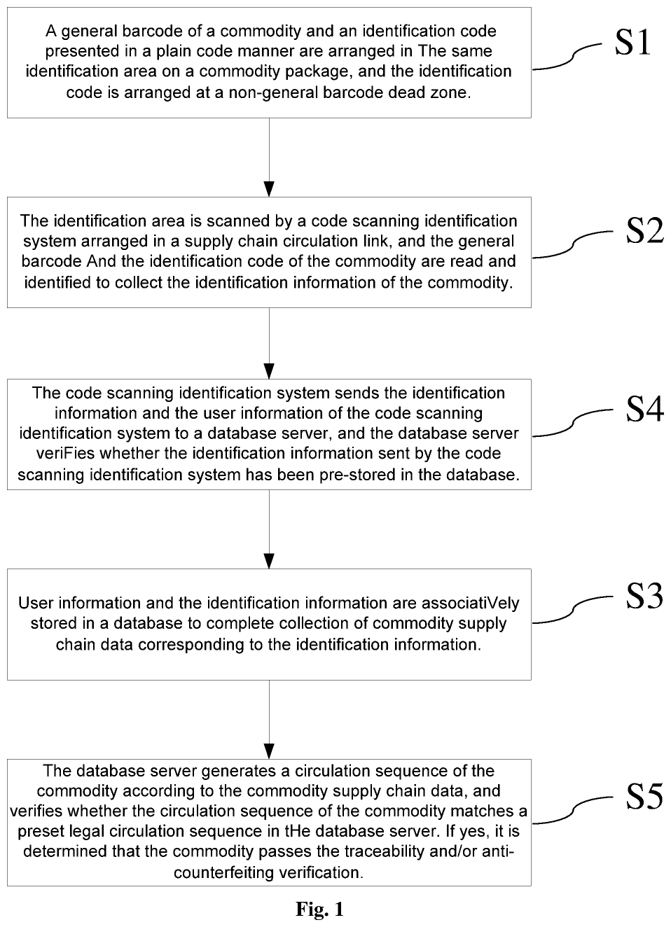

As shown in FIG. 1:

A supply chain data collection method compatible with standard article coding according to an embodiment of the present invention includes the following steps.

In S1, a general barcode of a commodity and an identification code presented unobstructed are arranged in the same identification area on a commodity package, and the identification code is arranged at a non-general barcode quiet zone. The general barcode and the identification code may be made on the commodity package by printing, print, laser coding, etc. The general barcode is an international general retail commodity or logistics unit barcode, for example, one of an EAN/UPC barcode and a UCC/EAN-128 barcode, or one of a one-dimensional EAN/UPC barcode and a UCC/EAN-128 barcode in a composite code. The identification code may be a random code or a code using a certain fixed coding law, for example, a character or a one-dimensional/two-dimensional barcode. Or, the identification code is printed after superimposing color and/or grayscale information on a general barcode area of the commodity. Identification information of the commodity is contained in a combination of the general barcode and the identification code or in the identification code. It should be pointed out that the general barcode refers to a commodity barcode used for the identification of commodities circulating in the domestic and international markets. Currently, the most widely used are EAN/UPC barcodes and UCC/EAN-128 barcodes in the GS1 system. The way of a plain code is different from the way of covering and shielding. The same identification area is to realize that the code scanning identification system can read the general barcode and the identification code through one operation, so as to avoid the wrong scanning of the wrong barcodes or missing scanning caused by human factors. The reason why the identification code is arranged at the non-general barcode quiet zone is to not affect the reading of the general barcode by the code scanning identification device, so as to achieve full compatibility with the standard article coding system.

In S2, the identification area is scanned by a code scanning identification system arranged in a supply chain circulation link, and the general barcode and the identification code of the commodity are read and identified to collect the identification information of the commodity.

In S3, user information and the identification information are associatively stored in a database (that is, a database in a database server) to complete collection of commodity supply chain data corresponding to the identification information.

By the present invention, the supply chain data collection method can be fully compatible with an existing standard article coding system, can quickly complete the collection of supply chain data with only one scanning operation, lays a foundation for “one article, one code” anti-counterfeiting traceability, effectively simplifies the operation steps of each circulation link in the supply chain and shortens the operation time, and improves supply chain data collection and identification efficiency. Moreover, the wrong scanning of wrong barcodes or missing scanning of identification codes caused by human factors is avoided, the integrity and credibility of supply chain data are improved, and it is also fully compatible with the existing standard article coding system, is easy to be accepted by all merchants in the supply chain, and is conducive to all-round promotion and application.

The supply chain data collection method of the present invention further includes the following step. In S4, after the identification information of the commodity is collected by the code scanning identification system, the identification information and the user information of the code scanning identification system are sent to a database server. The identification information is pre-stored in a database of the database server as an identity registration of the commodity. The user information of the code scanning identification system includes at least one of number, owner, and geographic location of the code scanning identification system. Before associatively storing the user information and the identification information, the database server verifies whether the identification information sent by the code scanning identification system has been pre-stored in the database. If yes, the database server associates the user information with the identification information for storage to complete the verification of supply chain data. In this way, the accuracy and completeness of supply chain data collection can be improved to facilitate the inquiry of commodity supply chain data, thereby further improving the effect of “one article, one code” anti-counterfeiting traceability.

Moreover, after scanning the identification area to read and identify the general barcode and the identification code of the commodity, the code scanning identification system arranged in the supply chain circulation link sends general barcode information to an information management system of the circulation link to complete data update of the information management system of the circulation link.

The supply chain data collection method of the present invention further includes the following step. In S5, after completing the collection of the commodity supply chain data, the database server generates a circulation sequence of the commodity according to the commodity supply chain data, and verifies whether the circulation sequence of the commodity matches a preset legal circulation sequence in the database server. If yes, it is determined that the commodity passes the traceability and/or anti-counterfeiting verification. The “one article, one code” anti-counterfeiting traceability is achieved, and the problem that the commodity is stolen and counterfeited to lose the anti-counterfeiting effect due to the authenticity check before being sold to a user can be avoided. The anti-counterfeiting identification effect is better, and the circulation of counterfeit and shoddy products is completely eliminated.

When a commodity package is a collective product outer package, identification information contained in a general barcode and an identification code arranged on the commodity package and identification information contained in general barcodes and identification codes of a plurality of commodities in the commodity package form a unique correspondence, and the correspondence is stored in the database to obtain identification information of each commodity in an inner package by querying identification information of a commodity on the outer package.

A collective commodity outer package is provided with a commodity code with a barcode and/or radio frequency tag as a unique commodity identification mark, the commodity code information is stored in the database, the commodity code information includes but is not limited to a Serial Shipping Container Code Barcode (SSCC), the commodity code information and identification information contained in general barcodes and identification codes of a plurality of commodities in the collective commodity outer package form a unique correspondence, and the correspondence is stored in the database to obtain identification information of each commodity in the outer package by querying the commodity code on the collective commodity outer package.

In addition, the supply chain data collection method of the present invention may also be implemented based on a blockchain technology, the database is a distributed database adopting the blockchain technology, and the identification information and associated supply chain data information are stored in the distributed database of a blockchain.

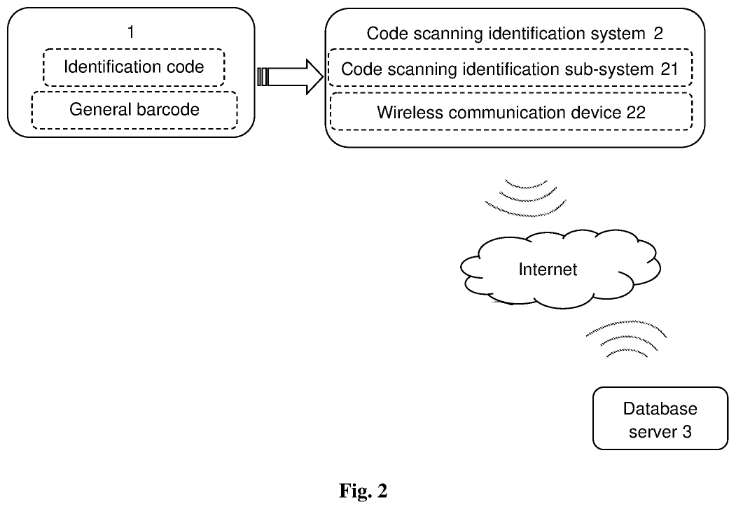

As shown in FIG. 2, a supply chain data collection system compatible with standard article coding of the present invention includes a general barcode and identification code 1, a code scanning identification system 2, and a database server 3. The general barcode and identification code 1 is arranged in the same identification area on a commodity package unobstructed, and the identification code being arranged at a non-general barcode quiet zone. The code scanning identification system 2 is arranged in a supply chain circulation link, includes a code scanning identification sub-system 21 and a communication device 22, and is mainly configured to scan the identification area of the commodity to read and identify the general barcode and identification code 1 of the commodity to collect the identification information of the commodity, and send the collected information and user information of the code scanning identification system 2 by the communication device 22 via a network (such as the Internet) to the database server 3. The code scanning identification sub-system includes an optical lens sub-system, a photoelectric sensing sub-system, an analog-to-digital conversion circuit sub-system, and a decoding sub-system. The photoelectric sensing sub-system is a photoelectric conversion module that converts optical signals into electrical signals. The decoding sub-system is an identification system capable of simultaneously decoding general barcodes and identification codes of commodities. For example, the code scanning identification system may be a computer system including a code scanning gun or a smart shelf or a smart shopping cart or a smart logistics tray, or a smart phone or tablet with a camera. The wireless communication device 22 may be a GPRS wireless communication module or a GSM wireless communication module (of course, it may also be a wired communication device), which is communicatively connected to the database server 3 via the Internet. The database server 3 is communicatively connected to the code scanning identification system 2 of each supply chain circulation link, and is mainly configured to store identification information contained in the general barcode and identification code 1, the user information of the code scanning identification system 2 in each supply chain circulation link associated with the identification information, and verify and feed back the received identification information of the commodity and the user information of the code scanning identification system 2. Specifically, the database server 3 is a supply chain database server compatible with standard article coding, and includes a receiving unit and a storage unit (not shown in the figures). The receiving unit is mainly configured to receive identification information of a commodity sent by a code scanning identification system in a supply chain circulation link, and own user information of the code scanning identification system. The identification information of the commodity is contained in a combination of a general barcode and an identification code or in an identification code, the general barcode and the identification code are arranged in the same identification area on a commodity package unobstructed, and the identification code is arranged at a non-general barcode quiet zone. The storage unit stores a database, and is mainly configured to store the identification information of the commodity received by the receiving unit, and the user information of the code scanning identification system. In this way, the supply chain data collection system of commodities can be fully compatible with the existing standard article coding system, which facilitates the completion of supply chain data collection and “one article, one code” anti-counterfeiting traceability.

The storage unit of the database server 3 may pre-store identification information as a commodity identity registration, and the database server 3 further includes a verification unit (not shown in the figures). The verification unit is mainly configured to verify whether the identification information of the commodity received by the receiving unit and sent by the code scanning identification system has been pre-stored in the storage unit before the storage unit stores the identification information of the commodity and the user information of the code scanning identification system, if yes, the verification unit confirms that the identification information of the commodity is verified, and then the storage unit associates the user information of the code scanning identification system with the identification information for storage.

The receiving unit of the database server 3 is further configured to receive a data request message of a user terminal, the database server 3 further includes a query unit (not shown in the figures) configured to query information stored in the storage unit that meets the requirements of the data request message according to the received data request message, and the database server further includes a sending unit (not shown in the figures) mainly configured to send the information that meets the requirements of the data request message to the user terminal.

In addition, the code scanning identification system 2 and the database server 3 in the supply chain data collection system compatible with standard article coding according to the embodiment of the present invention may also be connected to an online payment platform, and when the code scanning identification system 2 identifies commodity identification information that is checked by the database server 3, the code scanning identification system 2 sends a payment instruction to the online payment platform directly or sends a payment instruction to the online payment platform through the database server 3.

Similarly, the code scanning identification system 2 and the database server 3 in the supply chain data collection system compatible with standard article coding according to the embodiment of the present invention may also be connected to an online shopping platform, and when the code scanning identification system 2 identifies commodity identification information that is checked by the database server 3, the code scanning identification system 2 transmits commodity information or sends a payment purchasing instruction to the online shopping platform directly or transmits commodity information or sends a payment purchasing instruction to the online shopping platform through the database server.

Moreover, the supply chain data collection system compatible with standard article coding of the present invention may also be established based on a blockchain technology (that is, a blockchain technical structure is adopted), the database server is composed of distributed storage nodes of a blockchain, and the identification information of a commodity and supply chain data corresponding to the identification information are stored in the blockchain in a distributed manner.

Of course, if no identification code is arranged in the general barcode identification area of the commodity, the supply chain data collection system (code scanning identification system) of the present invention can also identify the commodity or goods general barcode.

The above is preferred implementation of the present invention. It is to be noted that a number of modifications and refinements may be made by those of ordinary skill in the art without departing from the principles of the present invention, and such modifications and refinements are also considered to be within the scope of protection of the present invention.

1. A supply chain data collection method compatible with standard article coding, comprising:
arranging a general barcode and an identification code of a commodity in a plain code manner in the same identification area on a commodity package, and arranging the identification code at a non-general barcode dead zone, wherein identification information of the commodity is contained in a combination of the general barcode and the identification code or in the identification code;
scanning the identification area by a code scanning identification system arranged in a supply chain circulation link, and reading and identifying the general barcode and the identification code of the commodity to collect the identification information of the commodity; and
associatively storing user information of the code scanning identification system and the identification information of the commodity in a database to realize collection of commodity supply chain data corresponding to the identification information.

2. The supply chain data collection method compatible with standard article coding according to claim 1, wherein the identification information of the commodity is pre-stored in the database as an identity registration of the commodity; after the identification information of the commodity is collected by the code scanning identification system, the identification information and the user information of the code scanning identification system are sent to a database server;
before associatively storing the user information and the identification information, the database server verifies whether the identification information sent by the code scanning identification system has been pre-stored in the database; and if yes, the database server associates the user information with the identification information for storage to realize the verification of supply chain data.

3. The supply chain data collection method compatible with standard article coding according to claim 1, wherein after scanning the identification area to read and identify the general barcode and the identification code of the commodity, the code scanning identification system arranged in the supply chain circulation link sends general barcode information to an information management system of the circulation link to realize data update of the information management system of the circulation link.

4. The supply chain data collection method compatible with standard article coding according to claim 1, wherein after completing the collection of the commodity supply chain data, the database server generates a circulation sequence of the commodity according to the commodity supply chain data, and verifies whether the circulation sequence of the commodity matches a preset legal circulation sequence in the database server; and
if yes, it is determined that the commodity passes the traceability and/or anti-counterfeiting verification.

5. The supply chain data collection method compatible with standard article coding according to claim 1, wherein the user information of the code scanning identification system comprises at least one of number, owner, and geographic location of the code scanning identification system.

6. The supply chain data collection method compatible with standard article coding according to claim 1, wherein the identification code is a character or a one-dimensional/two-dimensional barcode.

7. The supply chain data collection method compatible with standard article coding according to claim 1, wherein the identification code is printed after superimposing color and/or grayscale information on a general barcode area of the commodity.

8. The supply chain data collection method compatible with standard article coding according to claim 1, wherein the general barcode is one of an EAN/UPC barcode and a UCC/EAN-128 barcode, or one of a one-dimensional EAN/UPC barcode and a UCC/EAN-128 barcode in a composite code.

9. The supply chain data collection method compatible with standard article coding according to claim 1, wherein when a commodity package is a collective product outer package, identification information contained in a general barcode and an identification code arranged on the commodity package and identification information contained in general barcodes and identification codes of a plurality of commodities in the commodity package form a unique correspondence, and the correspondence is stored in the database to obtain identification information of each commodity in an outer package by querying identification information of a commodity on the outer package.

10. The supply chain data collection method compatible with standard article coding according to claim 1, wherein a collective commodity outer package is provided with a commodity code with a barcode and/or radio frequency tag as a unique commodity identification mark, the commodity code information is stored in the database, the commodity code information and identification information contained in general barcodes and identification codes of a plurality of commodities in the collective commodity outer package form a unique correspondence, and the correspondence is stored in the database to obtain identification information of each commodity in the outer package by querying the commodity code on the collective commodity outer package.

11. The supply chain data collection method compatible with standard article coding according to claim 1, wherein the method is implemented based on a blockchain technology, the database is a distributed database adopting the blockchain technology, and the identification information and associated supply chain data information are stored in the distributed database of a blockchain.

12. A supply chain data collection system compatible with standard article coding, comprising:
a general barcode and an identification code, arranged in the same identification area on a commodity package in a plain code manner, the identification code being arranged at a non-general barcode dead zone, wherein identification information of a commodity is contained in a combination of the general barcode and the identification code or in the identification code;
a code scanning identification system, arranged in a supply chain circulation link, comprising a code scanning identification sub-system and a communication device, and configured to scan the identification area of the commodity to read and identify the general barcode and the identification code of the commodity to collect the identification information of the commodity, and send the collected information and user information of the code scanning identification system by the communication device via a network to a database server; and
the database server, communicatively connected to the code scanning identification system of each supply chain circulation link, and configured to store identification information contained in the general barcode and the identification code, the user information of the code scanning identification system in each supply chain circulation link associated with the identification information, and verify and feed back the received identification information of the commodity and the user information of the code scanning identification system.

13. The supply chain data collection system compatible with standard article coding according to claim 12, wherein the code scanning identification sub-system comprises an optical lens sub-system, a photoelectric sensing sub-system, an analog-to-digital conversion circuit sub-system, and a decoding sub-system, the photoelectric sensing sub-system is a photoelectric conversion module that converts optical signals into electrical signals, and the decoding sub-system is an identification system capable of simultaneously decoding general barcodes and identification codes of commodities.

14. The supply chain data collection system compatible with standard article coding according to claim 12, wherein the code scanning identification system is a computer system comprising a code scanning gun or a smart shelf or a smart shopping cart or a smart logistics tray, or a smart phone or tablet with a camera.

15. The supply chain data collection system compatible with standard article coding according to claim 12, wherein the code scanning identification system and the database server are also connected to an online payment platform, and when the code scanning identification system identifies commodity identification information that is checked by the database server, a payment instruction is sent to the online payment platform directly or through the database server.

16. The supply chain data collection system compatible with standard article coding according to claim 12, wherein the code scanning identification system and the database server are also connected to an online shopping platform, and when the code scanning identification system identifies commodity identification information that is checked by the database server, commodity information is transmitted or a payment purchasing instruction is sent to the online shopping platform directly or through the database server.

17. The supply chain data collection system compatible with standard article coding according to claim 12, wherein the system is established based on a blockchain technology, the database server is composed of distributed storage nodes of a blockchain, and the identification information of a commodity and associated supply chain data are stored in the blockchain in a distributed manner.

18. A supply chain database server compatible with standard article coding, comprising:
a receiving unit, configured to receive identification information of a commodity sent by a code scanning identification system in a supply chain circulation link, and own user information of the code scanning identification system, wherein the identification information of the commodity is contained in a combination of a general barcode and an identification code or in an identification code, the general barcode and the identification code are arranged in the same identification area on a commodity package in a plain code manner, and the identification code is arranged at a non-general barcode dead zone; and
a storage unit, configured to store the identification information of the commodity received by the receiving unit, and the user information of the code scanning identification system.

19. The supply chain database server compatible with standard article coding according to claim 18, wherein
the storage unit pre-stores identification information as a commodity identity registration; and
the database server further comprises a verification unit for verifying whether the identification information of the commodity received by the receiving unit and sent by the code scanning identification system has been pre-stored in the storage unit before the storage unit stores the identification information of the commodity and the user information of the code scanning identification system, if yes, the verification unit confirms that the identification information of the commodity is verified, and then the storage unit associates the user information of the code scanning identification system with the identification information for storage.

20. The supply chain database server compatible with standard article coding according to claim 18, wherein
the receiving unit is further configured to receive a data request message of a user terminal;
the database server further comprises a query unit configured to query information stored in the storage unit that meets the requirements of the data request message according to the received data request message; and
the database server further comprises a sending unit configured to send the information that meets the requirements of the data request message to the user terminal.
